(19) United States
(12) Patent Application Publication
(10) Pub. No.: US 2004/0015379 A1
(43) Pub. Date: Jan. 22, 2004

(54) Raising an alert

(76) Inventor: David Mee, Worksop (GB)

Correspondence Address: HARNESS, DICKEY & PIERCE, P.L.C., P.O. BOX 828, BLOOMFIELD HILLS, MI, 48303, US

(21) Appl. No.: 10/447,743

(22) Filed: May 29, 2003

(30) Foreign Application Priority Data
May 31, 2002 (GB) GB 0212584.7
Oct. 18, 2002 (GB) GB 0224274.1
Mar. 26, 2003 (GB) GB 0306922.6

(51) Int. Cl. G06F 17/60

(52) U.S. Cl. 705/7; 705/10

(57) ABSTRACT

A method of locating a dependent person that has become separated from their caretaker in a high-density environment, comprising the steps of receiving from said caretaker a removable data-carrying medium containing a description of said dependent person, reading said description from said medium and distributing said description to a plurality of locations.

### BACKGROUND OF THE INVENTION

1. Field of the Invention

The present invention relates to an apparatus and method to raise an alert when a dependent person has become separated from their caretaker.

2. Description of the Related Art

Many common situations exist in which dependent persons are placed under the responsibility of a caretaker for instance young children are under the responsibility of their parents or miners, adults with learning difficulties accompanied by their carers, or older people with dementia in the care of their grown-up children.

Similarly, many situations exist in which such dependent persons may become separated from their respective caretakers, and give rise to an alert because a separated person is unable to rejoin their caretaker. An example of such a situation is a parent and a child visiting a high-density environment, such as a shopping mall, the parent being distracted by an occurrence and the child being similarly distracted away from the parent and walking away. In this situation, if the child goes out of sight of the parent there is a high probability that this will result in the child getting lost.

Systems are known to prevent such situations arising. Such systems, whether they involve low technology such as a harness-and-leash combination or high technology such as failsafe radio wave-based transponders, have had comparatively little success, having regard to the frequency with which undesirable situations as described above happen compared to the uptake of such systems. Thus there remains the problem for caretakers caught out in such situations to raise an alert based upon the most accurate description possible of the lost dependant in the shortest available time. Unfortunately, the accuracy of the required information is often unsatisfactory to achieve a fast recovery, either because said information is provided entirely subjectively, for example in terms of approximate height, weight, facial features and so on, or because it is provided in a format which is not suitable for fast distribution to multiple media-broadcasting systems, for example a printed photograph.

### BRIEF DESCRIPTION OF THE SEVERAL VIEWS OF THE DRAWINGS

FIG. 1 shows a caretaker accompanying two dependants in a high-density environment;

FIG. 2 illustrates a networked environment, including processing systems sharing data over said network environment, such as user terminals, cell phones and servers, some of which are located within said high-density environment;

FIG. 3 shows a processing system configured to process and encode a description comprising at least an image of the dependents shown in FIG. 1;

FIG. 4 details hardware components of a processing system of the type illustrated in FIGS. 2 and 3, including a memory;

FIG. 5 summarises actions performed at a processing system illustrated in FIGS. 2 to 4 to input, encode and write a description comprising at least an image of a dependant shown in FIG. 1;

FIG. 6 illustrates the contents of the memory shown in FIG. 4, upon inputting data as shown in FIG. 5, including an encoding module and a database;

FIG. 7 further summarises the step of configuring the processing system of FIGS. 2 to 4 to process input data as shown in FIG. 5;

FIG. 8 illustrates the contents of the temporary data structure shown in FIG. 5, within which the user-inputted data shown in FIG. 7 is to be stored, and including a default extended mark-up language (XML) script;

FIG. 9 shows an example of the default XML script shown in FIG. 8 to be updated by means of the database shown in FIG. 7 according to the encoding step shown in FIG. 5;

FIG. 10 further summarises the steps of inputting and processing data as shown in FIGS. 5 and 6 to update the database shown in FIG. 7;

FIG. 11 is a diagrammatic representation of the data processing flow, as summarised in FIGS. 5 to 10;

FIG. 12 illustrates the contents of the temporary data structure shown in FIGS. 5, 8 and 11 upon completing the process shown in FIG. 11;

FIG. 13 is a diagrammatic representation of the encoded data writing flow, as summarised in FIG. 5, including a removable data-carrying medium;

FIG. 14 shows alternative embodiments of the data-carrying medium shown in FIG. 13 and onto which the final encoded data shown in FIGS. 12 and 13 may be written;

FIG. 15 shows the caretaker shown in FIG. 1 having lost one dependent in the high-density environment of FIGS. 1 and 2;

FIG. 16 shows the caretaker shown in FIG. 15 providing a security officer, who has a processing system, with the removable data-carrying medium shown in FIG. 13;

FIG. 17 details hardware components of the processing system shown in FIG. 16, including a memory;

FIG. 18 summarises actions performed at the processing system of FIG. 17 to read, decode and display and/or broadcast data representing at least an image of the lost dependant first shown in FIG. 1;

FIG. 19 further summarises the step of configuring the processing system of FIG. 17 to broadcast data as shown in FIG. 18, including a step of constructing hypertext mark-up language (HTML) pages;

FIG. 20 illustrates the contents of the memory shown in FIG. 17 upon decoding data as shown in FIGS. 18 and 19, including a decoded description;

FIG. 21 shows the decoded description shown in FIG. 20 selectively broadcast within the networked environment shown in FIG. 2 to raise an alert about the lost dependent first shown in FIG. 1.

### BEST MODE FOR CARRYING OUT THE INVENTION

An embodiment of the invention will now be described by way of example only with reference to the previously identified drawings.

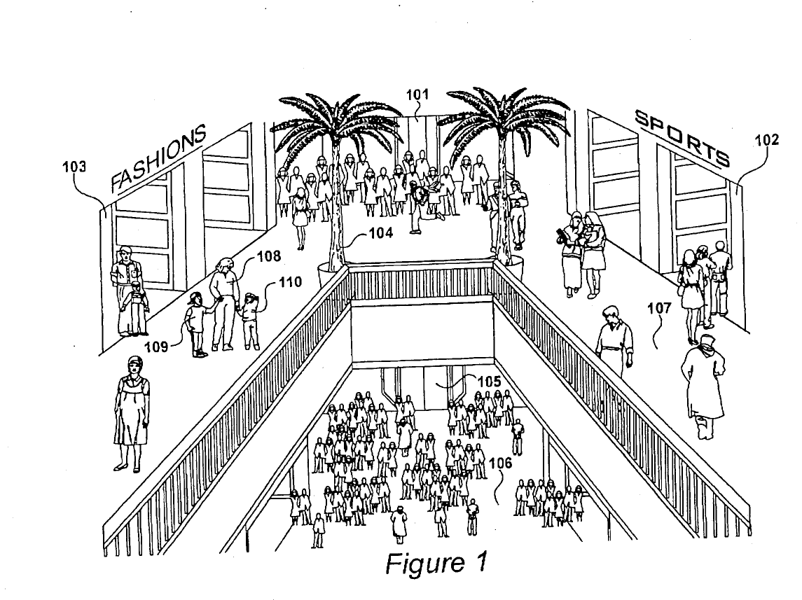

FIG. 1

FIG. 1 shows a responsible person, or caretaker, visiting a high-density environment with two accompanying dependent persons.

In the example, an internal representation of said high-density environment is shown as a conventional shopping mall 101, having multiple retail outlets 102, 103 and/or points of particular interest 104, 105 located along alleyways, possibly spread over multiple floor levels 106, 107. In the example said caretaker is a parent 108 accompanying her two children 109, 110.

In the event of either or both children 109, 110 becoming separated from parent 108 during the visit, say child 109, conventional wisdom would have parent 108 first attempting to locate said separated child 109 and, if unsuccessful after a period of time, then contacting the local security officers for assistance.

Parent 108 would then have to provide the name and describe the weight, height and physical attributes of child 109, and the accuracy of such information would be fairly essential for achieving a fast recovery of child 109, especially if a photograph were not carried at the time, for instance as a keepsake. Even if a photograph were carried and supplied to assist the description at the time, it would be printed material that would take time and specialist equipment such as a scanner to digitise locally then broadcast to local, internal display systems. In situations such as herein described, time is of the essence and so delays in putting out information regarding the dependent person should be minimised. A further shortcoming of a conventional photograph is its ephemeral nature, since the lost child 109 pictured thereon may have outgrown his or her likelihood in the picture, for instance if the photograph carried as a keepsake is of child 109 as a toddler, thus making the photograph useless to assist the description at the time.

Thus, in the event of child 109 becoming lost during the mall visit, it is most likely that an accurate description including a readily-distributable image of the child would not be obtained before an extended period of time had elapsed, during which time efforts to locate said child 109 would be based solely upon two types of information, some of which being accurate but ineffective for the task, such as the name of child 109. The rest of the information would be based on the parent's subjective view of the child, such as the weight, height and physical attributes of child 109.

Thus there is herein described an apparatus for raising an alert to the above situation in which child 109 has become separated from parent 108, which comprises encoding and writing the information required to provide an accurate description, including at least an image of child 109, onto a removable data-carrying medium, then reading and decoding said information to generate at least one viewable image and distributing said image to a plurality of locations around said facility 101.

Parent 108 should initially encode and write said information, including at least an image of child 109, onto said removable data-carrying medium, and this initial data-entry activity may be carried out at varying locations, which are preferably but not necessarily network-connected. Similarly, the locations to which said information may have to be distributed if child 109 is lost may vary to a large extent, either in terms of physical locations or in terms of addressable locations. What is meant by addressable locations is locations connected by a network, and said information distribution preferably takes place across said networked environment.

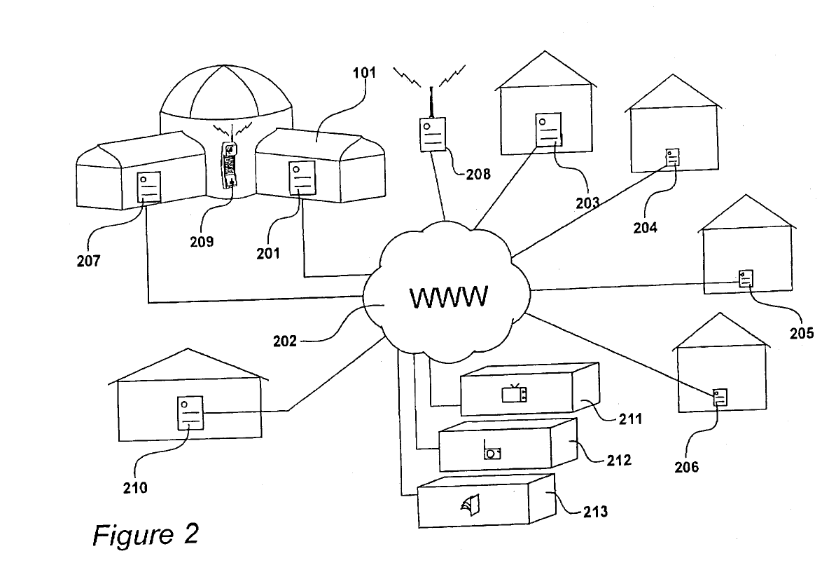

FIG. 2

FIG. 2 illustrates an example of said networked environment, including said physical and addressable locations, some of which are located within mall 101.

A first networked location 201 is shown physically located within mall 101 and connected to the Internet 202. In the current embodiment of the present invention, location 201 is a self-contained, one-time-purchase booth configured with a processing system and input means with which parent 108 may encode and write the required information onto a removable data-carrying medium, wherein said processing means and input means will be described below in further detail. In an alternative embodiment, location 201 is a self-contained booth configured as above, but wherein parent 108 may encode and write an updated set of said required information onto said removable data-carrying medium, for instance when child 109 has grown up to the extent that current descriptive information is redundant.

The operation of any of said booths may be coin-based, creditor debit card transaction-based or even linked to retail loyalty card schemes wherein credits for system as herein described are acquired as a reward. It will be readily apparent that any type of transaction may be used.

A plurality of further networked locations are shown, which are all connected to the Internet 202 and, potentially, may send and receive data such as the information described with reference to FIG. 1. As is the case with booth 201, it is processing systems physically located within said networked locations that are connected to the Internet 202. Such processing systems may thus include a network server 203 which may send and receive data to the processing system of said booth 201 across the Internet 202.

Similarly, private processing systems 204, 205 and 206 respectively represent privately-owned domestic personal computers, at which caretakers may encode and write information describing their dependent persons in a manner similar to parent 108 at booth 201. It will be appreciated that the invention is not limited to the current description and that any system that can encode and write a dependant's description, including at least an image, onto a removable data-carrying medium may be used in place of booth 201 or personal computers 204 to 206.

Further addressable locations include for instance another network server 207 processing data for the security force of mall 101 and, in a current embodiment of the present invention, sending data input therein to an SMS, GPRS or G3 networked server 208, the function of which is to wirelessly broadcast said data to respectively WAP, GPRS or G3-compatible mobile telephone handsets 209, with which security officers within mall 101 are preferably equipped. Such handsets 209 are capable of processing, wirelessly distributing and locally displaying image data. Other addressable locations to which said information and image may be sent may also include processing systems operated by official emergency services, such as processing system 210 operated by the police and, further, processing systems 211, 212 and 213 respectively located at a television broadcasting facility, a radio broadcasting facility and a newspaper office, for the purpose of broadening the alerts if so required.

Thus, each of the physical locations described within the networked environment shown in FIG. 2 includes at least one processing system, which is preferably but not necessarily connected to the Internet 202. Indeed, although the network connectivity to the Internet 202 is not necessary to achieve the encoding and writing of the required information and image data onto the removable data-carrying medium, it is desirable for the subsequent distribution of said information and image describing child 109 when required.

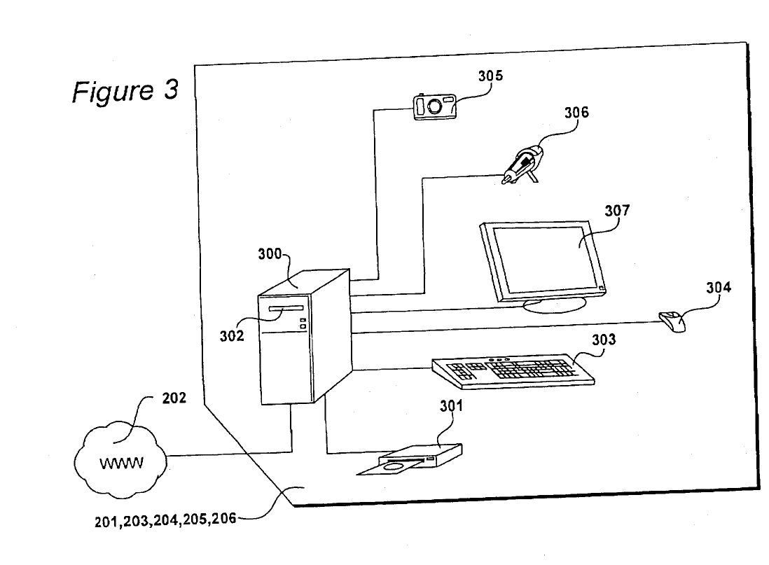

FIG. 3

FIG. 3 shows a processing system such as systems 201 and 203 to 206 with which to process input data representing at least an image of children 109, 110 to be subsequently encoded and written to the removable data-carrying medium.

A generic programmable computer 300, such as a personal computer, is shown in FIG. 3, the hardware components of which will be described below in further detail. Said system 201 is connected to a plurality of devices with which to input said information data, including said image data, and with which to write said data when encoded, by means of writing said encoded data onto a removable data-carrying medium.

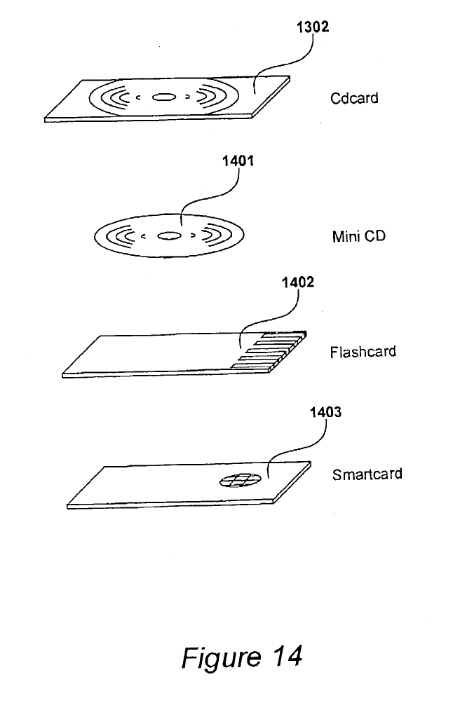

Firstly, in order to write said encoded data, a data-writing means is required, the type of which will vary according to which type of removable data-carrying medium is used. In this embodiment said removable data-carrying medium is a credit card-shaped and credit card-sized rewritable CD, and so the data-writing means is a combination DVD-reader and CD-rewriter 301, but it will be readily understood by those skilled in the art that the invention is not limited to optical removable media and may be similarly implemented using any other type of removable data-carrying medium, various types of which will be further described below with reference to FIG. 14. The data-writing means will therefore vary accordingly as being a suitable means to write upon the medium used.

In order to write the data onto a removable data-carrying medium the programmable computer 300 is configured with a plurality of data input means specific to the type of data to be input, thus comprising alphanumeric data input means which in this example is keyboard 303, and, optionally, a directional input device to specify where to input said alphanumeric data such as a mouse 304. The programmable computer 300 is further configured with image data input means, which in this example is a digital camera 305. It will be readily apparent that other image data input means, such as a scanner, could be used. In this embodiment the programmable computer 300 is also configured with analogue input means, which in this example is a microphone 306, although this is not provided in other embodiments of the invention.

Preferably the programmable computer 300 is also equipped with a video display unit 307, by means of which the user of said system 201, such as parent 108, may visualise the data that has been input by means of input means 303 to 306, and assess the accuracy thereof, and a ZIP™ drive 302.

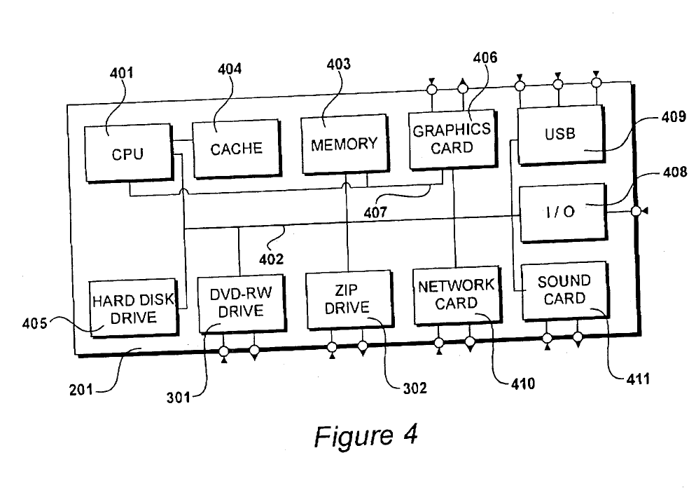

FIG. 4

The components of computer system 201 are further detailed in FIG. 4. The system includes a Pentium 4™ central processing unit (CPU) 401 which fetches and executes instructions and manipulates data via a system bus 402 providing connectivity with a larger main memory 403, DVD-ROM™ re-writer 301, ZPT™ drive 302 and other components which will be further detailed below. System bus 402 is, for instance, a crossbar switch or other such bus connectivity logic. CPU 401 is configured with a high-speed cache 404 comprising between two hundred and fifty-six and five hundred and twelve kilobytes, which stores frequently accessed instructions and data to reduce fetching operations from larger memory 403. Memory 403 comprises between two hundred and fifty-six megabytes and one gigabyte of dynamic randomly accessible memory and stores executable programs which, along with data, are received via said bus 402 from a hard disk drive 405. Hard disc drive (HDD) 405 provides non-volatile bulk storage of instructions and data.

A graphics card 406 receives graphics data from the CPU 401, along with graphics instructions. Said graphics accelerator 406 is preferably coupled to the CPU 401 by means of a direct port 407, such as the advanced graphics port (AGP) promulgated by the Intel Corporation, the bandwidth of which exceeds the bandwidth of bus 402. Preferably, the graphics card 406 includes substantial dedicated graphical processing capabilities, so that the CPU 401 is not burdened with computationally intensive tasks for which it is not optimised.

Input/output interface 408 provides standard connectivity to peripherals such as keyboard 303 and mouse 304. A Universal Serial Bus (USB) 409 is provided as an alternative means of providing connectivity to peripherals such as keyboard 303, mouse 304 and digital camera 305, whereby said connectivity is improved with a faster bandwidth for user input data transfer. A Firewire™ interface may also be provided as an alternative means of providing connectivity to camera 305, whereby said connectivity is improved with a bandwidth for image data transfer yet faster than said USB 409.

Network card 410 provides connectivity to the internet 202 by processing a plurality of communication protocols. A sound card 411 is provided which receives sound data from the CPU 401 over system bus 402 along with sound processing instructions, or analogue sound data from the microphone 306 to be digitised therein, in a manner similar to graphics card 406. Preferably, the sound card 411 includes substantial dedicated digital sound processing capabilities, so that the CPU 401 is not burdened with computationally intensive tasks for which it is not optimised.

The equipment shown in FIG. 4 constitutes an inexpensive programmable computer of fairly standard type, such as a programmable computer known to those skilled in the art as an IBM™ PC compatible or an Apple™ Mac. However any computer having the necessary components could be used.

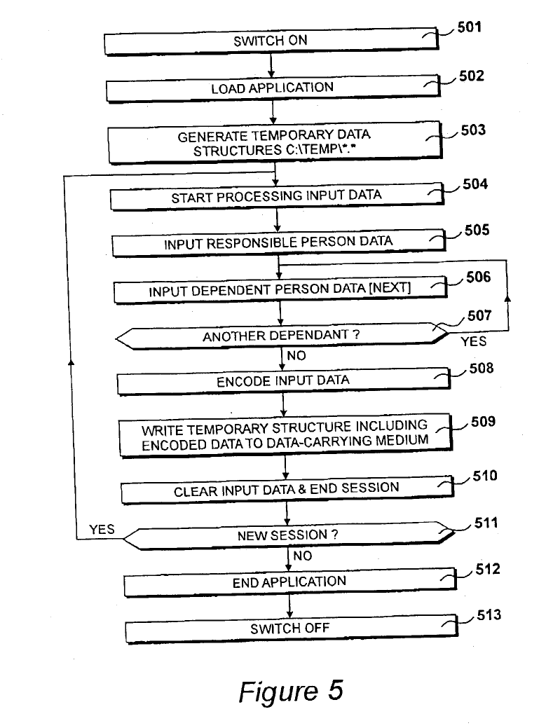

FIG. 5

The operational steps according to which a responsible person may interact with a processing system, such as programmable computer 300, in order to encode data describing a dependent person are detailed in FIG. 5.

At step 501 the programmable computer 300 is switched on, whereby all instructions and data sets necessary to process image data are loaded at step 502, including instructions to encode data describing a dependent person. Alternatively, said instructions and data sets are loaded from a data-carrying medium (normally not the same as removable data-carrying medium 302) inserted and read by DVD-ROM™ 301 or ZIP™ drive 302, or loaded from network server 203 over the Internet 202 at step 502, for instance if said instructions are not yet stored on hard disk drive 405. Upon completing the loading operation of step 502, the processing of said instructions by CPU 401 starts at step 503, whereby a temporary data-storing structure is first generated in said HDD 405, such that CPU 401 may then process input data according to said instructions from step 504 onwards and store said processed input data in said temporary data structure for encoding upon eventually completing said data entry.

Data describing any dependant should preferably be input by the person responsible for said dependant and thus data describing said responsible person is preferably first input at step 505. This ensures the integrity and the accuracy of the dependent person's data when it is either input or retrieved. In an alternative embodiment of the present invention, however, the removable data-carrying medium contains data describing only said dependent person and not the responsible person, whereby each dependent person of a group such as a family requires a respective removable data-carrying medium.

Upon completing said step 505, the data required to describe and/or represent the first dependant, for example child 109, is input at the next step 506, including at least an image of child 109. At step 507 a question is asked as to whether data required to describe and/or represent another dependant should be input, for example data required to describe and/or represent the second child 110.

If the question asked at step 507 is answered in the affirmative, control is returned to step 506 such that said data can be input. Alternatively, if the question asked at step 507 is answered in the negative then the data entry steps are complete and the data input according to steps 505 to 507 and processed according to the rules started at step 504 may now be encoded at step 508 and subsequently written to a data-carrying medium at step 509.

Upon completing the writing step 509, the temporary data structure generated at step 503 is re-initialised at step 510, whereby all of the data input and processed between steps 504 and 509 is irretrievably deleted from said structure. At step 511 a question is asked as to whether a new session should be started, whereby if this question is answered in the affirmative control should be returned to step 504 such that a fresh set of input data describing the same or a different responsible person and the same or different dependent persons may be processed, encoded and written.

In an alternative embodiment of the present invention wherein the data on the removable data-carrying medium may be updated, then if the question asked at step 511 is answered in the affirmative said responsible person may update said data required to describe and/or represent any of said dependants, for instance the image of child 108 input at step 506, by means of DVD-rewriter device 301 rewriting said updated image onto said rewritable, removable data-carrying medium.

In the present embodiment, wherein the apparatus described in FIG. 3 is configured as said self-contained, one-time-purchase coin-operated booth shown in FIG. 2, an initial financial transaction, such as the depositing of a requisite sum in a coin-slot, may for instance provide a positive answer to question 511.

Alternatively, the question asked at step 511 is answered in the negative, whereby the operator of programmable computer 300 is at liberty to stop the processing of the instructions at step 512 and, eventually, switch programmable computer 300 off at step 513.

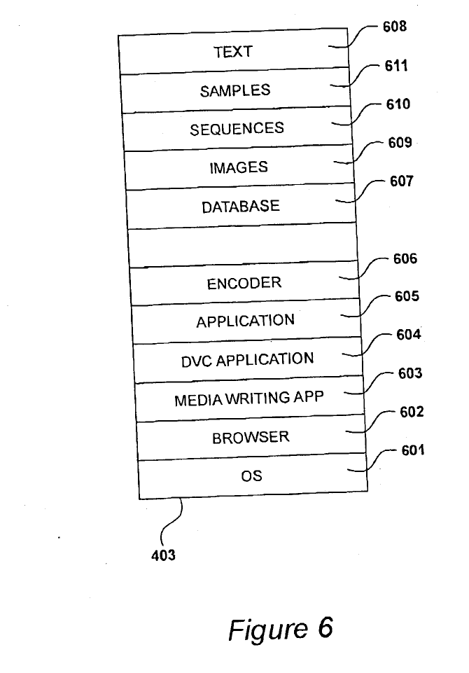

FIG. 6

The contents of main memory 403 subsequent to the starting of the input data processing step 504 shown in FIG. 5 are further detailed in FIG. 6.

An operating system is shown at 601 which comprises a reduced set of instructions for CPU 401, the purpose of which is to provide programmable computer 300 with basic functionality. Examples of basic functions include, for instance, access to files stored on hard disk drive 405 or accessed from DVD/CD ROM drive 301 or ZIP drive 302 and management thereof, network connectivity with network server 203, the Internet 202 and camera 305, interpretation and processing of the input from keyboard 303 and mouse 304. In the example, the operating system is Windows XP™ provided by the Microsoft corporation of Redmond, Calif., but it will be apparent to those skilled in the art that the instructions herein described may be easily adapted to function under different other known operating systems, such as other versions of the Windows operating system, MAC OS-X™ provided by Apple Corporation, IRIX™ provided by Silicon Graphics Inc, or LINUX, which is freely distributed.

An internet browser application is shown at 602 which processes data packets coded by both hypertext mark-up language (HTML) and extended mark-up language (XML), or other internet-specific formatted data, into graphical data for display on VDU 307. A digital video capture application is shown at 603 which processes digital video image data generated by camera 305 and accessed at USB interface 409 into graphical data for display on VDU 307 and processing by the instructions herein described. A medium writing application is shown at 604 which processes final encoded input data into specific medium-formatted binary data and manages transfer of said data between the hard disk drive 405 and/or the memory 403, and the removable data-carrying medium when inserted in the CD-writing device 301.

The instructions are shown as application 605, which configures the CPU 401 to process input data according to steps 504 to 511. Corresponding application data is shown which comprises various sets of user-independent data and user-dependent data, to be subsequently encoded and written to a removable data-carrying medium at steps 508 and 509 respectively. Said encoding step 508 requires an encoding module 606, the function of which is to translate a database storing field-indexed strings of alphanumeric values, such as ASCII characters input by means of keyboard 303, into a processable XML or Java script.

Said database is shown at 607 and constitutes said user-independent data. Said database is described as user-independent insofar as it is a non-modifiable database template, which may only receive and index input data as said strings of alphanumeric values, such as said ASCII characters input by means of keyboard 303.

Conversely, said user-dependent data comprises said strings of alphanumeric values, shown as text input data at 608. It also comprises non-alphanumeric data, preferably such as image data 609 obtained via digital camera 305 and digitised by application 603, whereby said digitising is preferably carried out at varying high and low resolutions and stored as JPEG-formatted files. Image data 609 comprises photographs of parent 108, child 109 and child 110, and can thus be considered as representing each of these. In this embodiment said user-dependent data also comprises sequences of such photographs constituting videoclips 610, also obtained via digital camera 305 and digitised by application 603 and preferably stored as MPEG1-formatted file, and sound samples as voice files 611 obtained via microphone 306 and digitised by soundcard 411 and preferably stored as WAV-formatted or MP3-formatted files. However in other embodiments of the invention the non-alphanumeric data may comprise only image data 609, and/or may only represent a single dependent child.

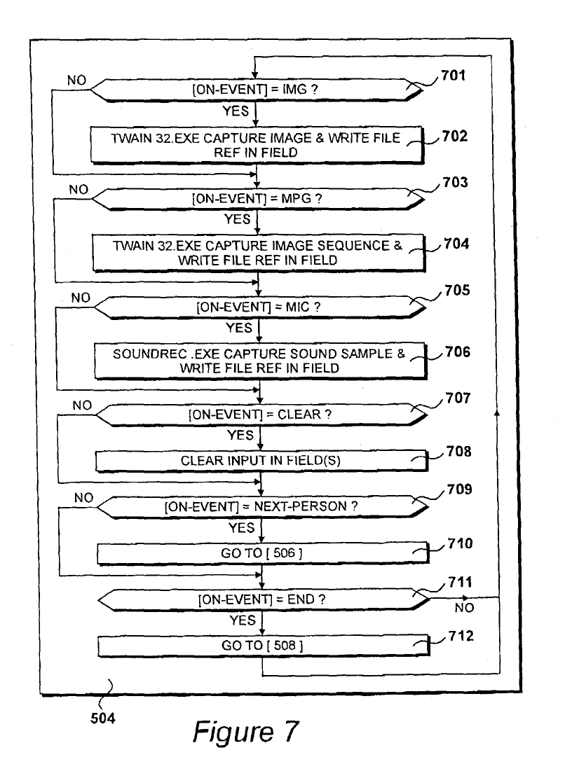

FIG. 7

The step 504 of configuring the programmable computer 300 to process input data is further described in FIG. 7. In effect, said step 504 comprises enunciating a set of conditional rules and corresponding processing decisions for CPU 401 to follow in order to accurately process input data according to which type of data is input. Said conditional rules and processing decisions are shown as steps which are interactively processed by CPU 401 in a never-ending loop called a thread. Said thread is processed concurrently with any other applications processed by said CPU 401 until all of the required information data, including at least one image, has been processed.

A first question is asked at step 601 as to whether an event triggered by the user of programmable computer 300 interacting with key board 303 or mouse 304, for instance parent 108 pressing a key or clicking a mouse button, specifies that the application loaded at step 502 should now process image data 609. If the question asked at step 701 is answered in the affirmative, the instructions 605 configure CPU 401 to process the capture application 604 shown as “twain 32”, thus capture image data by means of digital camera 305, whereby said image data is stored in memory 403 as an image file and application 605 generates a reference in database 607 uniquely identifying said file.

Alternatively, if the question asked at step 701 is answered in the negative control is forwarded to the next question 703, asking this time whether the event triggered by the user identifies input data as a video clip. If the question asked at step 703 is answered in the affirmative, application 605 performs in the same calls and functions as described in relation 702, but additionally configures the capture application 604 to capture image data as a sequence of successive image frames, as opposed to the single image frame captured at said step 702. Thus, said input sequence 610 is similarly stored in memory 403 as a file, which is uniquely referenced within database 607 by application 605.

Alternatively, the question asked at step 703 is answered in the negative, whereby control is forwarded to the next question 705, asking whether the triggered event identifies input data as a sound sample. If the question asked at step 705 is answered in the affirmative, application 605 configures CPU 401 to call for soundcard 411 to digitise the analogue sound sample input by means of microphone 306, shown as “sound rec”. As was previously the case for image data 609, 610, said digitised sample 611 is stored in memory 403 as a sound file and, again, uniquely referenced within database 607 by application 605.

Alternatively, if the question asked at step 705 is answered in the negative and control is forwarded to the next question 707, asking whether the triggered event identifies a condition requiring application 605 to erase any data so far input. If question 707 is answered in the affirmative, application 605 initialises database 607, whereby all of the data 608 to 611 so far input is deleted from memory 403 and the user of programmable computer 300 may start inputting information data afresh.

Alternatively, the question asked at step 707 is answered in the negative, whereby control is directed to the penultimate question 709, asking whether the triggered event identifies a condition for application 605 to end processing information data relating to a first person and start processing input data relating to a next person. Thus if the question of 709 is answered in the affirmative, application 605 configures CPU 401 to carry out the processing step 506. Alternatively, the question asked at step 709 is answered in the negative, whereby the control is forwarded to the last question 711, asking whether the triggered event signals to application 605 that all of the required information data has been input.

If the question asked at step 711 is answered in the affirmative, then at step 712 application 605 configures CPU 401 to start encoding input data 607 to 611 according to processing step 508. Alternatively, if the question asked at step 711 is answered in the negative, control is returned to the first question 701 and so on and so forth until such time as question 711 is answered in the affirmative.

In an alternative embodiment of the present invention, the sound digitising and storing step 706 is jointly processed with the frame sequence capturing step 704 when answering question 703 in the affirmative, the respective image data and sound data of which are multiplexed by encoder 606 at step 508 in order to generate a video clip with sound, for instance conforming to the MPEG1 or AVI file formats.

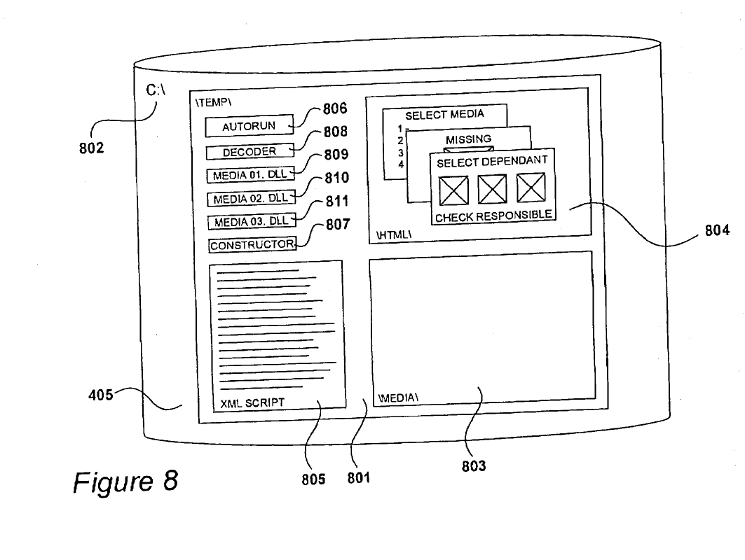

FIG. 8

The input data 608 to 611 shown in FIG. 6 are processed according to the input data processing rules of step 504 further described in FIG. 7 and temporarily stored in volatile memory 403 until application 605 is instructed to encode said input data at step 508, whereby said input data is moved from memory 403 to the temporary data structure generated in hard disk drive 405 at step 503. Said temporary data structure is illustrated in FIG. 8, within which the user-input data shown in FIGS. 5 to 7 are to be stored.

In the current embodiment, the temporary data structure is generated as a file folder “temp” 801 depending directly from the root drive designation 802. It will be readily apparent, however, to those skilled in the art that the denomination and location of temporary file folder 801 are unimportant.

The temporary data structure 801 comprises further said sub-directories configured to respectively store varying data types. For instance, a first sub-directory “media” 803 preferably groups input data 609, 610 and 611, eg photographs, frame sequences and sound samples respectively. Another sub-directory “HTML” 804 groups all the data files which, when processed by CPU 401 configured by browser 602, generate standard HTML pages viewable within the graphical user interface of said browser on VDU 307, wherein said HTML pages are colloquially known as “web” pages.

The temporary data structure or main directory 801 also comprises a default XML script 805, which will be described in further detail below. Said default script 805 is created by means of the encoder 606 encoding database 607 therein such that, when said script 805 is decoded and processed by a browser-type application 602, said default web pages stored in sub-directory 804 are updated with both the alphanumeric data initially input in said database 607 and also the various non-alphanumeric data stored in subdirectory 803 and referenced therein.

In effect, the temporary data structure 801 is generated at step 503 as a self contained and self executing application which only requires information data including at least one image and, as such, said temporary directory also includes instruction sets. A first, “autorun”, instruction set 806 is generated within directory 801, the function of which is to configure the central processing unit of any processing system reading the removable data-carrying medium to process the data carried thereon, regardless of the user of such a system effecting such a processing operation. A second, “constructor”, instruction set 807 is also generated within directory 801, the function of which is to create a permanent data structure on the non-volatile storage means of said host processing system in a manner similar to the generation of directory 801 in programmable computer 300, and extract all of the contents of the removable data-carrying medium in their respective data structures 803, 804 and 805, by invoking a decoder module 808 to decode and regenerate the XML script 805 updated by database 607 before it was initially written onto said data-carrying medium. For this purpose, said third “decode” instruction set 808 is also generated within directory 801 at said step 503.

Although most operating systems like system 601 feature a basic multi-media processing capability, ie the capacity to process image data 609 for display, this is not always true, and so in the current embodiment of the present invention further format-specific instruction sets 809, 810 and 811 are generated within directory 801 to configure the central processing units 401 of said eventual host processing system to respectively process image data 609, frame sequences 610 and sound samples 611 when they are loaded from said data-carrying medium. However in other embodiments of the invention these are not provided.

In the example shown herein child 109 gets lost in a mall in his own country, but if said child 109 got lost during the family holidays in a foreign country, it would be preferable for the contents of said data-carrying medium to be generated in their respective data structures 803, 804 and 805 in the language of said foreign country. Thus, in another embodiment of the present invention (not shown), an interpreter instruction set is similarly generated, the sole purpose of which is to interrogate the language setting of the operating system 601 of the host processing system in order to configure decoder module 808 to decode and regenerate the XML script 805 in the local language.

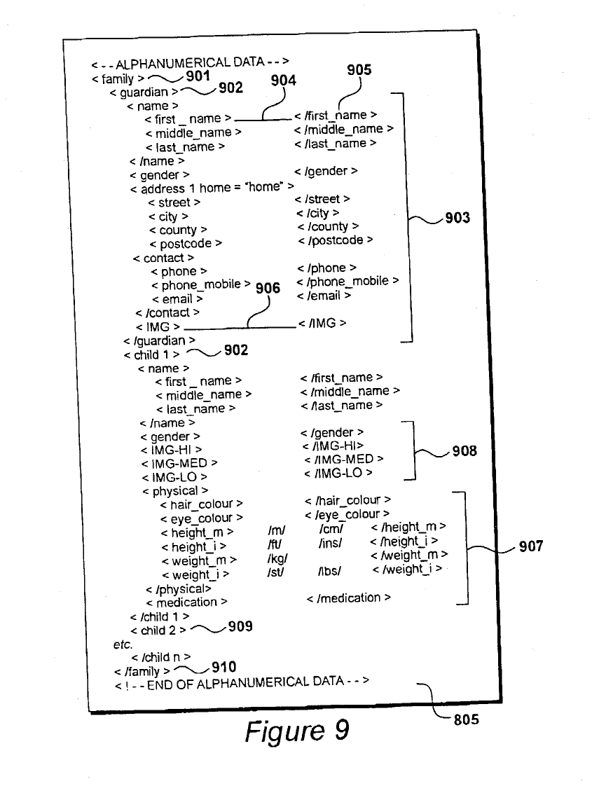

FIG. 9

The default XML script 805 shown in FIG. 8 to be updated by means of encoding the database 607 shown in FIG. 6 is described in further detail in FIG. 9. For the purpose of clarity, said script 805 is shown as uncompiled, edited pseudo XML code.

The extensible market language (XML) is used in this description of the current embodiment of the present invention, but it defines an extremely simple dialect of the standard generalised market language (SGML), the international standard (ISO 8879:1985) for defining descriptions of the structure of different types of electronic documents. XML is a light-weight, cut-down version of SGML, which keeps enough of its functionality to make it useful because it can be used to store any kind of structured information and to enclose or encapsulate information in order to pass it between differing computer systems, which would otherwise be unable to communicate. As such it will be understood that most other variations of mark-up languages and even programming languages, such as C++, may be used. As such the word “encoding” will be understood not to be restricted to creating XML documents as herein described, but to mean the processing of some or all of the data in database 607 into the language used. (The exact meaning of “decoding” should also be understood to vary according to the language used.) The software module which performs this task is an encoding module.

Generally XML documents are made up of storage units called entities, which contain either parsed or unparsed data. Parsed data is made up of characters, some of which form the character data in the document and some of which form mark-up. Mark-up encodes a description of the documents storage layout and logical structure. XML provides a mechanism to impose constraints on the storage layout and logical structure.

In the current embodiment the encoder module is a module called an XML processor. This is used to read XML documents and to provide access to their content and structure. It is assumed that an XML processor is doing its work on behalf of another module, called the application. This specification describes the required behaviour of an XML processor in terms of how it must read XML data and the information it must provide to the application.

The pseudo XML code 901 is shown configured with a structure 902 simplifying the compartmenting of the information data input in respect of each person to be described on said removable media. It was previously explained that said input information data comprises a mix of alphanumeric (608), image (609, 610) and aural (611) data, wherein said alphanumeric data 608 is stored in database 607 and unique references to said image and aural data 609 to 611 are similarly stored in said database 607.

It is therefore preferred that the successive entities 902 containing parsed data 903 reflect the field structure of said database 607. In accordance with the XML general description thereabove, said parsed data 903 thus includes characters, some of which form the character data 904 in the eventual HTML document and some of which form mark-up 905. According to the current embodiment of the present invention, said character data 904 is input by the user of programmable computer 300 as either said alphanumeric data 608 or generated by application 605 to uniquely reference a media file, as shown at 906.

According to this embodiment, the data describing the caretaker such as parent 108 and her contact details as well as an image of her are first input. Input data describing a first dependant, structurally shown at 902, is then input according to step 506 and preferably in further detail as shown at 907 as well as a plurality of images as shown at 908. If the question asked at step 507 is answered in the affirmative, data describing yet another dependent, such as child 110 structurally shown at 909 is again input by parent 108, with being structured when encoded from database 607 into XML script 805 similarly to parsed data 903 to 908, and so on and so forth until all dependents and/or caretakers thereof have been so described, such that the initial structural entity “family” 901 is terminated at 910. However in an alternative embodiment referred to above each card only contains data referring to a single dependant and so the XML script only contains information relating to that dependant. It will thus be appreciated that the exact structure of the XML script is not important, as long as it can be updated by means of encoding the database 607.

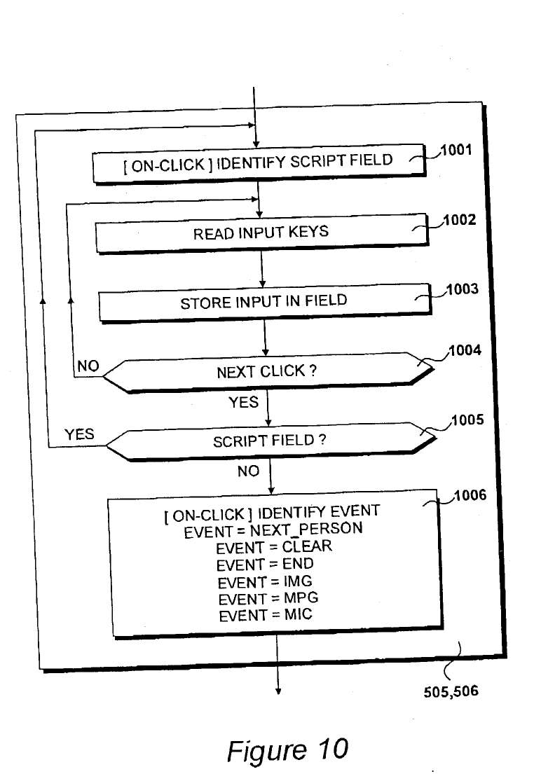

FIG. 10

The steps 505 and 506 of inputting and processing data shown in FIG. 6 to update the default XML scripts 805 described in FIG. 9 are detailed in FIG. 10.

As previously explained, step 504 configures CPU 401 to process input data according to a set of conditional rules which were detailed in FIG. 7. Thus, any interaction by the user of programmable computer 300 further to step 504 is interpreted by said processing system according to sets of conditional rules, whereby when the caretaker begins the data inputting process according to step 505, application 605 first identifies the field of database 607 which said user has selected by means of interacting with keyboard 303 or pointing device 304 at step 1001 such that alphanumeric values 608 may be read from said keyboard 303 at step 1002 as the database field update, or value, which may subsequently be stored therein at step 1003.

A question is then asked at step 1004 as to whether the user, which in this example is parent 108, has interacted with either keyboard 303 or pointing device 304 and said interaction has produced input data different from an expected alphanumeric value 608, for instance a numerical value in a field at which, by definition should only contain letters, such as a family name. If the question asked at step 1004 is answered in the negative, control is returned to step 1002, whereby the next keystroke is read and stored in the field identified according to step 1001 and so on and so forth. Alternatively, the question asked at step 1004 is answered in the affirmative and a second question is asked at step 1005 as to whether said non-alphanumeric input data identifies another database field, for instance if all of said fields are presented to parent 108 on VDU 307 and said parent clicks each subsequent field for data input upon updating each previous one.

Thus if the question asked at step 1005 is answered in the affirmative, control is returned to step 1001, whereby said field-identifying data input is processed in order to identify said selected field. Alternatively, the question asked at step 1005 is answered in the negative, whereby said input data is processed according to the conditional rules enunciated at step 504 and is treated as identifying an event as opposed to a database field to be processed according to any of processing steps 702, 704, 706, 708, 710 or 712.

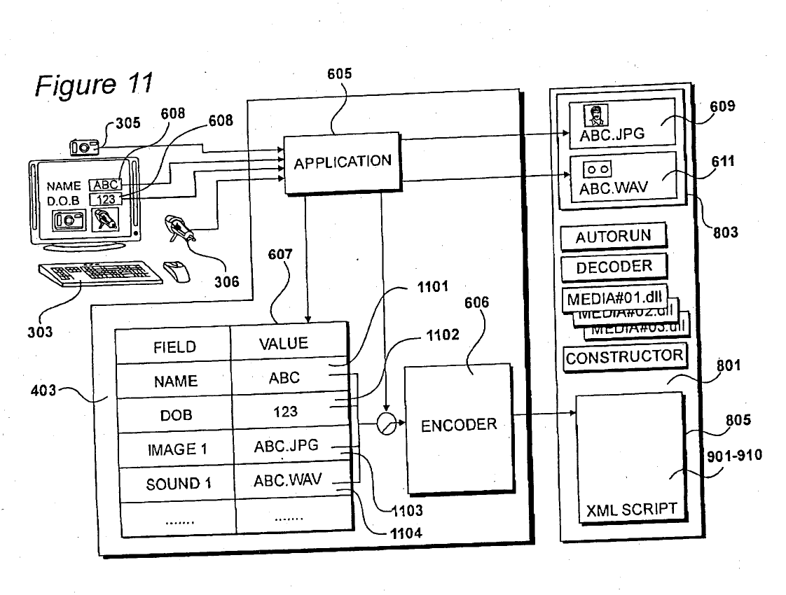

FIG. 11

The data processing flow is diagrammatically represented in FIG. 11, wherein the input data read and stored according to the processing steps shown in FIGS. 5, 7 and 10 is moved to the temporary data structure 805 described in FIGS. 8 and 9, including the step of encoding the database 607 into said default XML script 805.

The temporary directory 801 is thus shown with all of its default contents 802 to 811, including the default XML script 805 having XML code 901 to 910 but within which character data 904 has yet to be encoded. In the example, parent 108 wishes to configure a removable data-carrying medium by writing encoded data thereon describing her children 109 and 110, including at least an image of each child. In accordance with the description of the present embodiment, parent 108 first inputs alphanumeric data 608 by means of keyboard 303, having identified respective database fields 1101 and 1102 by means of mouse 304. Upon completing the input of alphanumeric data 608, parent 108 interacts with mouse 304 to generate an event-triggering processing step 702, whereby digital camera 305 captures an image 609 of parent 108, a unique alphanumeric identifier of which is generated by application 605 in database field 1103.

If required, parent 108 further interacts with mouse 304 to generate an event-triggering processing step 706, whereby parent 108 provides an analogue voice sample through microphone 306 which is digitised and consequently stored as a sound sample 611, a unique alphanumeric identifier of which is generated by application 605 in database field 1104.

Parent 108 then inputs description data for each of her children 109, 110 in a similar manner and in accordance with the present description until her interaction with mouse 304 identifies an event-triggering processing step 712, thus triggering the encoding of said input data according to step 508. Said encoding step comprises application 605 invoking encoder 606 to process all of the alphanumeric values stored in database fields such as field 1101 to 1104 into XML character data 904 to update the full XML script 805 at respective positions. Thus, in the example, the unique alphanumeric reference “ABC.JPG” of the image data 609 representing parent 108 and stored in database field 1103 is encoded by encoder 606 into XML character data 906, and so on and so forth.

Application 605 writes all of the media-type data 609 to 611 to the media sub-directory 803 of main temporary directory 801 whilst encoder 606 encodes alphanumeric data. Thus, in the example, said image data 609 is moved from memory 403 to said directory 803 on hard disk drive 405, as is the sound sample 611.

The above data processing flow is carried out until all of the data input by parent 108 has been respectively encoded and stored in said temporary directory 801.

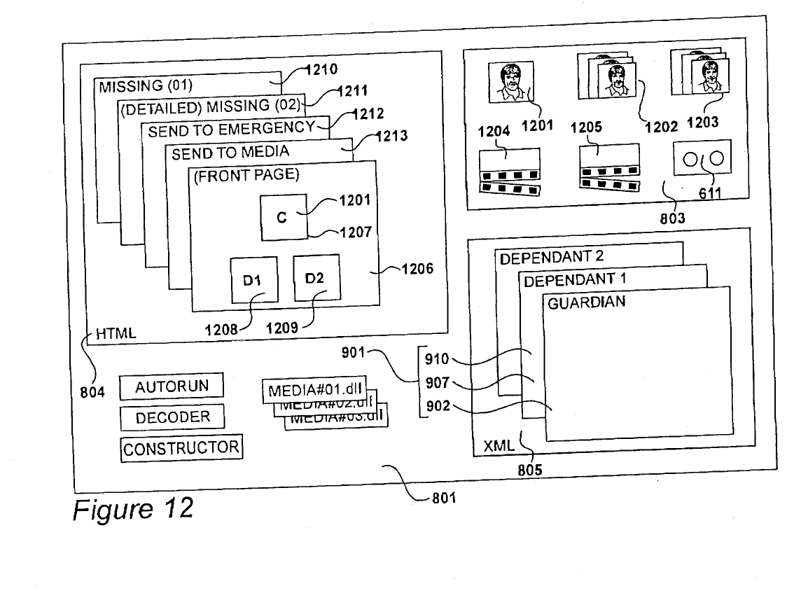

FIG. 12

The contents of said temporary main directory 801 shown in FIGS. 5, 8 and 11 upon completing said data processing flow are illustrated in FIG. 12.

The file folder “temp” 801 is shown and stores the first sub-directory “media” 803, wherein media input data is stored. In the example, said media input data includes a photograph 1021 of parent 108, a set 1202 of high, low and medium resolution photographs of child 109 and a set 1203 of high, low and medium resolution photographs of child 110. Said media input data further includes a voice file 611 of parent 108, a video clip 1204 of child 109 and a video clip 1205 of child 110.

The file folder “temp” 801 is also shown as storing the second sub-directory “HTML” 804, wherein the data files to be processed by CPU 401 configured by a browser application to generate standard HTML pages, respectively define HTML templates within which the above media input data stored in directory 803 and the alphanumeric input data 607, 608 encoded in XML script 805 will be inserted upon decoding said script 805.

A first, front HTML page template 1206 is configured by script 805 to display an image of the caretaker at 1207, such as for instance photograph 1201, as well as at least one image of each dependent, for instance medium-resolution photographs of children 109, 110 respectively, at 1208 and 1209, whereby upon viewing said page 1206 generated by said browser application at any processing system 201 to 213, a user may readily verify the identity of the caretaker and instantly identify which dependant is lost from its respective photograph.

The HTML templates also include a plurality of pages 1210 to 1213 specifically configured to raise an alert about the dependant identified by means of their respective photograph. Thus, a second page 1210 is configured by script 805 as a ‘missing’ poster to be printed, featuring at least one image, preferably a high-resolution photograph from the sets 1202 or 1203 depending upon which child is lost, as well as a portion of the child's respective alphanumeric input data, such as a name, surname and date of birth. A third page 1211 is configured by script 805 as an alternative ‘missing’ poster to be printed, again featuring at least one image, preferably a medium-resolution photograph from the sets 1202 or 1203 depending upon which child is lost, as well as all of the child's respective alphanumeric input data.

Other function-specific pages may be included, such as a fourth page 1212 configured by script 805 as the above ‘missing’ poster 1211, thus including all details, to be distributed to emergency services within the networked environment described in FIG. 2, such as the police. Preferably, a fifth page 1213 is included and configured by script 805 as the above ‘missing’ poster 1212, thus including all details but also including media data 611 and 1204, 1205, to be distributed to media broadcasting companies within the networked environment described in FIG. 2, such as television stations, radio stations and newspaper offices.

It will be readily apparent to those skilled in the art that many other HTML templates can be used and that the specific format is not important. Additionally, HTML is a current standard for computers that is easily viewed and shared and so is used in this current embodiment, but any other alternative processable format may be used.

As shown in FIG. 8, directory 801 further includes instruction sets 806 to 811. These are unchanged by the data processing flow.

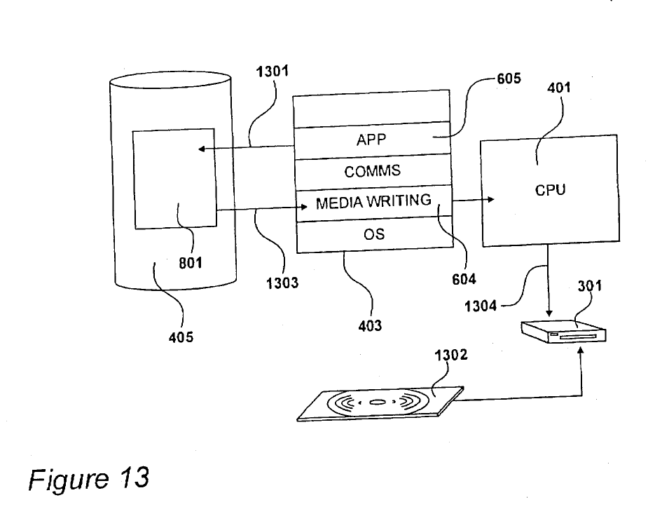

FIG. 13

In much the same way as FIG. 11 diagrammatically represents the data processing flow for inputting and decoding data, FIG. 13 provides a diagrammatic representation of the writing flow onto a removable data-carrying medium.

Upon completing the step 508 of encoding the data input by parent 108 whereby application 605 has completed updating the contents of temporary data structure 801 in HDD 405 shown in further detail in FIG. 12 according to the data processing flow summarised in FIG. 11 and schematically shown as 1301, application 605 next calls for media writing application 603 to configure CPU 401 for writing said updated directory 801 including the encoded data to a removable data-carrying medium 1302 according to step 509 by means of medium writer 301.

Said media-writing application 603 first fetches (1303) all of the data contained in directory 801 that is to be written onto said removable data-carrying medium back into memory 403, wherein said data is processed by CPU 401 into specific medium-formatted binary data and, when so processed, is then physically written (1304) onto medium 1302. Upon completing said writing operation 509 (1304), the medium 1302 may be removed from medium writer 301 and subsequently carried by parent 108.

Thus removable data-carrying medium 1302 contains several types of data: firstly it contains encoded data in the form of XML script 805, secondly it contains audio and image data 803, thirdly it contains HTML templates 804 and fourthly it contains instruction sets 806 to 811. The first two types of data can together be considered as descriptions of the persons thereon (parent 108 and children 108, 109). Although the audio and image data is not itself encoded, the XML script 805 contains the references that explain what each item is, and so, for each person, their entire description is in effect encoded. As discussed previously, other languages could be used to encode the data stored in database 607, with possibly the image and audio data being encoded also if the need arose, and so an encoded description of a person can be considered as data, including image data representing the person, at least some of which is encoded.

Additionally the HTML pages generated from the templates, which include some or all of data 607 to 611 bound thereto, can be considered as viewable images generated from the descriptions. These are different from the image data in that they contain copies of some or all of the image data but are themselves only viewable images of that data. As previously described the format of the templates could be anything considered appropriate by the operators of a system such as herein described, and so the viewable image could comprise any alphanumeric, audio or image data in addition to the image of the lost dependent person. In other embodiments it is feasible that the HTML templates could be contained within the processing system 207 rather than on the removable data-carrying medium 1302, with the security officer prompted for their location on inserting medium 1302. This would allow the security force conducting the search to choose the format of the pages, rather than the company that issues the cards.

Thus the removable data-carrying medium has on it an encoded description of a dependent person, said encoded description including image data representing said person. It also has on it instruction sets that configure a computer to decode and read an encoded description of a dependent person, create a viewable image therefrom and distribute said viewable image.

FIG. 14

In the current embodiment of the present invention, said removable data-carrying medium 1302 is a credit card-sized and -shaped compact disc but it will be readily apparent to those skilled in the art that many other types of removable data-carrying media may store encoded data. Accordingly, alternative removable data-carrying media are shown in FIG. 14, onto which the final encoded data 801 may be written.

The use of the word “removable” in this description refers to the fact that the data-carrying medium is designed to be removed from the medium writer which wrote the data to it and transported to any other location. It may subsequently be placed in the same medium writer, or, more pertinently, in a similar one on a different computer to be read or, if possible, to have further data written to it. For example, hard disk drive 405 is not a removable data-carrying medium because although it could be removed from computer 300 it would be difficult to do so, and also difficult to place it within another computer.

However, although the media described below must all be physically placed within a data-writing or input means to be written to or read from respectively, the definition also comprehends wireless writing of data, for example it is now possible to download files to a cellphone. Thus the phrase “removable data-carrying medium” includes any medium that is easily transportable by an individual, and that can have information written to and read from it by any computer that is configured to do so. The media described below all fall within this definition.

The credit card-type CD medium is here preferred because it offers an advantageous compromise between data storage capacity and medium size. Indeed the medium 1302 of the current embodiment may easily be stored in a wallet like a business card or a credit card and thus is much more likely to be carried by the caretaker, eg parent 108, at the time of either of her dependent children 109, 110 becoming lost. Said medium 1302 is also known as a “CD card” or more colloquially as a “saddle card” and is an optical-based data storage device having a storage capacity comprised between twenty five and one hundred and twenty five megabytes.

A first alternative is a mini-CD-R 1401, having a standard storage capacity of one hundred and eighty five megabytes. Such a medium would be particularly suited in situations where caretakers require fairly exhaustive information, including lengthy video clips 610, for many dependent persons. This might be particularly useful for a teacher accompanying a school trip. Medium 1401 is however much less practical an item to carry in purses or wallets on a regular basis.

A second alternative is for the data to be written to a high speed, solid state memory card NAND-based flash memory technology in conjunction with an ATA controller chip set. This type of removable data-carrying medium is not optical like media 1302 and 1401 but emulates a bulk storage device such as hard disk drive 405, thus providing the capability to easily capture, retain and transport data including audio and image data. Various types of memory cards 1402 briefly comprise ATA flash memory PC cards, compactflash memory cards, smartmedia memory cards and SRAM memory cards. Memory cards of this type feature a storage capacity comparable to CD card 1302. Advantageously, data such as final encoded data 801 written thereto may be accessed and updated repeatedly on memory cards 1402, while said data written to media 1302 or 1401 may not be updated on said optical media with currently-available technology.

A third alternative removable data-carrying medium is a smart card 1403. Like CD card 1302 and memory card 1402, the smart card 1403 is also credit card-sized but, unlike said media 1302 and 1402, it is preferably made of flexible plastic, such as polyvinyl chloride or PVC. The smart card 1403 is embedded with a micro module containing a single silicon integrated circuit chip having certain key components that allow it to execute instructions supporting the card's functionality. It features a micro processor unit which executes programmed instructions, an input-output controller managing the flow of data between a card acceptance device (the card reader) and the above micro processor, a program memory within which the instructions executed by the micro processor units are permanently stored by the micro module manufacturer. It also features random access memory comparable to memory 403 of processing system 300 and, finally, application memory which is almost always EPROM (electrically erasable programmable read-only memory), within which the final encoded data 801 would be written. Although smart card 1403 has a much smaller data storage capacity than any of media 1302, 1401 and 1402, its cost is negligible compared to said media and it is much more durable whilst featuring the same data-updating facility as medium 1402.

It will be understood by those skilled in the art that the above removable data-carrying media are here described as examples only and that the present description is not limited thereto. This area of technology is fast-moving and so it is not possible to give an exhaustive list of the options.

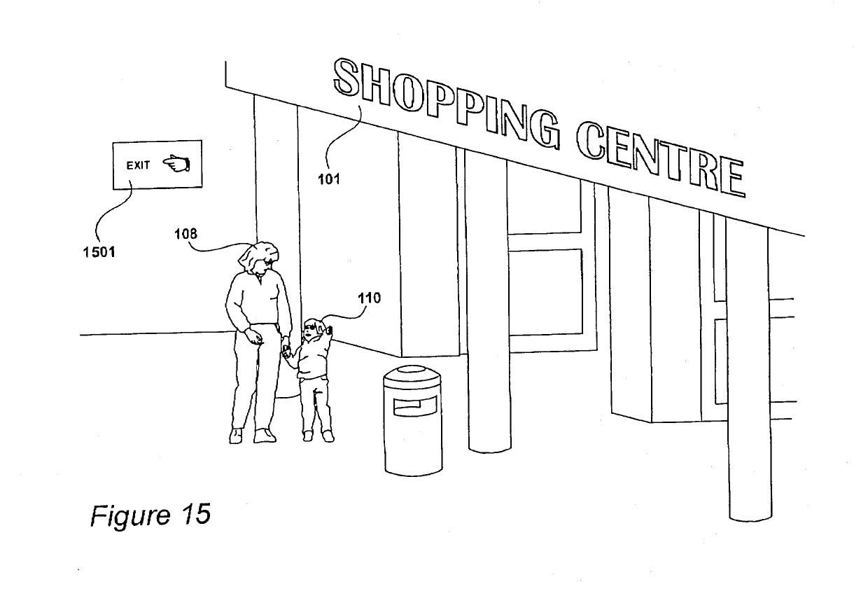

FIG. 15

FIG. 15 shows parent 108 becoming aware of the absence of child 109 upon exiting (1501) the shopping mall 101, having previously written an encoded description 801 including at least one image 1208, 1209 of each child 109, 110 respectively onto the removable data-carrying medium 1302. In the example, parent 108 and child 110 were distracted by the goods on display in the window of shop 103, while child 109 was similarly distracted away from parent 108 by the goods on display in the window of shop 102. Child 109 walked away from the family group and got lost.

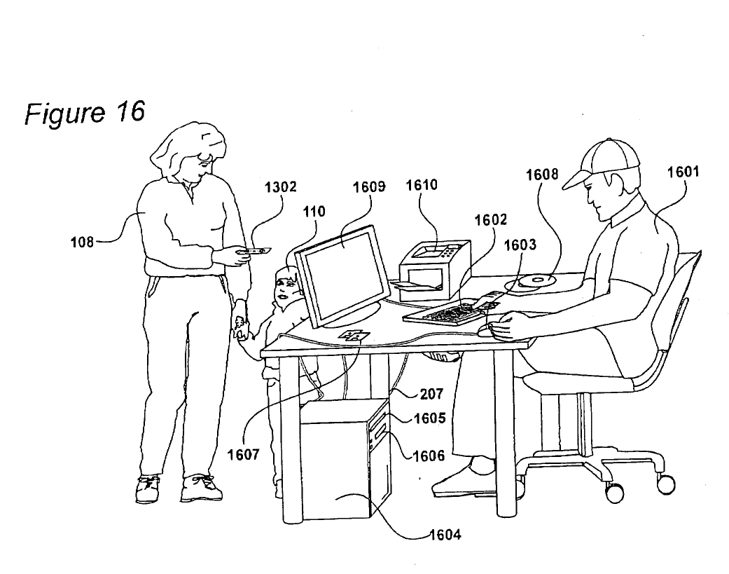

FIG. 16

Parent 108 then immediately contacts the security force of mall 101 for assistance and provides the security officer that is operating security force processing system 207 with removable data-carrying medium 1302, as shown in FIG. 16.

The processing system 207 operated by security officer 1601 preferably comprises standard features, whereby manual input is provided via a keyboard 1602 and a mouse 1603 to a programmable computer 1604. Said programmable computer 1604 is equipped with a drive 1605 for receiving optical media, such as media 1302, as well as a drive 1606 for receiving magnetic disks, such as standard floppy disk 1607. Drive 1605 can be considered as input means configured to receive a removable data-carrying medium. Clearly if other types of media are used, as described with reference to FIG. 14, other input means must be used also. While the embodiments shown in FIG. 14 are received within an input means by being physically placed inside it, any communication between a removable data-carrying medium and an interface is comprehended by the word “receive”, since if a wireless input means is used no physical contact between the medium and the input means is necessary.

Computer 1604 may also receive program instructions via an appropriate CD-ROM 1608 or from disk 1607 and output data may be written thereto. Moreover, instructions may be transmitted to and received from the internet 202, to which computer 1604 is connected as described in FIG. 2. Output data processed by computer 1604 is preferably visualised on a video display unit 1609. It can also be printed on printer 1610.

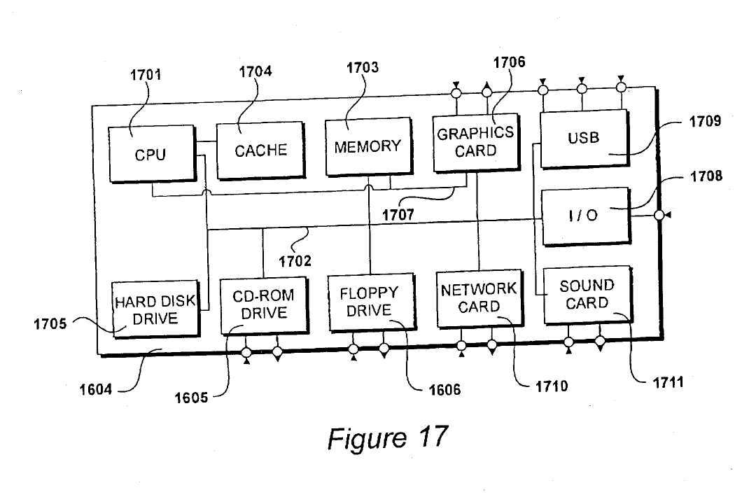

FIG. 17

The components of computer 1604 are further detailed in FIG. 17. The system includes a Pentium 4™ central processing unit (CPU) 1701 which fetches and executes instructions and manipulates data via a system bus 1702 providing connectivity with a larger main memory 1703. CD-ROM reader 1605, floppy-disk drive 1606 and other components which will be further detailed below. System bus 1702 is, for instance, a crossbar switch or other such bus connectivity logic. CPU 1701 is configured with a high-speed cache 1704 comprising between two hundred and fifty-six and five hundred and twelve kilobytes, which stores frequently-accessed instructions and data to reduce fetching operations from larger memory 1703. Memory 1703 comprises between two hundred and fifty-six megabytes and one gigabyte of dynamic randomly accessible memory and stores executable programs which, along with data, are received via said bus 1702 from a hard disk drive 1705. Hard disk drive (HDD) 1705 provides nonvolatile bulk storage of instructions and data.

A graphics card 1706 receives graphics data from the CPU 1701, along with graphics instructions. Said graphics accelerator 1706 is preferably coupled to the CPU 1701 by means of a direct port 1707, such as the advanced graphics port (AGP) promulgated by the Intel Corporation, the bandwidth of which exceeds the bandwidth of bus 1702. Preferably, the graphics card 1706 includes substantial dedicated graphical processing capabilities, so that the CPU 1701 is not burdened with computationally intensive tasks for which it is not optimised.

Input/output interface 1708 provides standard connectivity to peripherals such as keyboard 1602 and mouse 1603. A Universal Serial Bus (USB) 1709 is provided as an alternative means of providing connectivity to peripherals such as keyboard 1602 and mouse 1603, whereby said connectivity is improved with a faster bandwidth for user input data transfer. Output means is preferably provided in this example by network card 1710, which provides connectivity to the internet 202 by processing a plurality of communication protocols. However it could in other embodiments be provided by a network card configured for an internal network, if the dependant's description is only to be distributed over a limited area. Output means is also, but less preferably, provided by the printer. A sound card 1711 is provided which receives sound data from the CPU 1701 over system bus 1702 along with sound processing instructions, or analogue sound data from the microphone 306 to be digitised therein, in a manner similar to graphics card 1706. Preferably, the sound card 1711 includes substantial dedicated digital sound processing capabilities, so that the CPU 1701 is not burdened with computationally intensive tasks for which it is not optimised.

The equipment shown in FIG. 17 constitutes an inexpensive programmable computer of fairly standard type, such as a programmable computer known to those skilled in the art as an IBM™ PC compatible or an Apple™ Mac. It will be readily apparent that it differs only in immaterial details from the equipment shown in FIG. 4. Like the computer shown in FIG. 4, it is only an example and any computer having the necessary components could be used.

In this example computer 300 can read and write to the removable data-carrying medium whereas processing system 207 can only read, but in other embodiments processing system 207 could also write to the medium. It is also possible that the two computers could actually be the same, ie that the security force is responsible for issuing the removable data-carrying media.

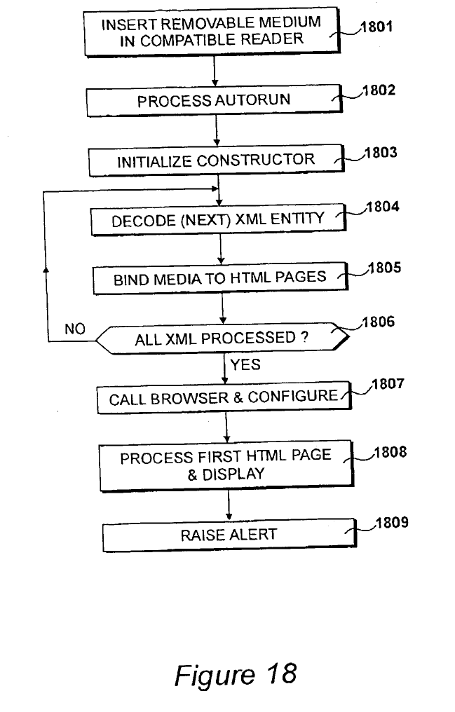

FIG. 18

Actions performed at the programmable computer 1604 upon parent 108 handing over removable medium 1302 to security officer 1601 and said medium 1302 being received by optical media drive 1605 in order to read, decode and display or broadcast data relating to lost child 109 are summarised in FIG. 18.

At step 1801, security officer 1601 inserts the removable card CD 1302 into the CD reading device 1605, whereby the autorun instruction set 806 is immediately processed at step 1802 by CPU 1701 in accordance with the principle described in FIG. 8.

Thus, the second, constructor, instruction set 807 is initialised at step 1803 and creates a permanent file folder, in the example a “temp” directory, on the root of hard disk drive 1705. Upon creating a local copy of directory 801, constructor 807 starts to generate HTML pages therein having decoded data, including at least one image 609 thereon, by means of invoking the decoding module 808 to decode the XML script 805 written at step 509.

Said decoding module 808 interactively processes entities 901 to 910, whereby upon parsing media data-indicative mark-up XML code it binds the corresponding media to the corresponding HTML page location at step 1805. Thus, in the example, said decoding module 808 would parse marker 906 and bind the image data 609 to HTML page location 1201.

At step 1806 a question is asked as to whether all of the XML entities have been processed. If the question is answered in the negative, control is returned to step 1804, whereby the next entity in XML script 805 is processed, eg decoded. Alternatively, the question asked at step 1806 is answered in the affirmative, signifying that all of the HTML pages including decoded data and at least said image data 609 have been generated within the directory created at step 1803. The constructor's last task at step 1807 is to call a browser-type application preferably stored in memory 1703 and comparable in functionality to browser 602, to start processing the HTML pages generated between steps 1803 to 1806 at step 1808 for output and display on VDU 1609.

In the present embodiment, said step 1807 of calling said browser-type application further comprises the step of configuring said browser-type application with dynamically loaded modules, also known as plugins, to process media data such as data 609 to 611 which the browser may not be initially configured to process, wherein said plugins are instruction sets 809 to 811.

Upon said browser application displaying said first HTML page 1202 on to said VDU 1609, security officer 1601 now raises a “missing dependant” alert at step 1809 by distributing all or a portion of the input data 608 to 611 decoded at step 1804 and regenerated within said HTML page 1202.

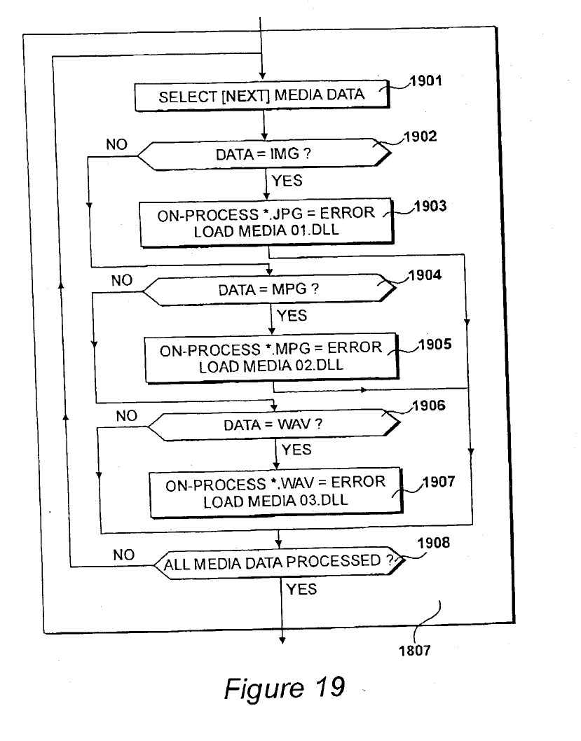

FIG. 19

The step 1807 of configuring the browser-type application to process media data stored in folder 803 for binding at the next step 1808 and subsequent broadcasting at step 1809 is further described in FIG. 19.

At step 1901 the first media data 609, 610 or 611 is selected for processing, whereby a first question is asked at step 1902 as to whether said media data is image data 609. If the question of 1902 is answered in the affirmative, a first HTML processing condition is stated, whereby if the browser attempts to process said image data 609 at the next step 1808 and returns an error, said browser should load the first specific media processing plugin 809 at step 1903. Control is then forwarded to step 1908.

Alternatively, the question asked at step 1902 is answered in the negative whereby a second question is asked at step 1904 as to whether said media data is videoclip data 610. If the question of 1904 is answered in the affirmative, a second HTML processing condition is stated, whereby if the browser attempts to process said videoclip data 610 at the next step 1808 and returns an error, said browser should load the second specific media processing plugin 810 at step 1905. Control is then forwarded to step 1908.

Alternatively, the question asked at step 1904 is answered in the negative whereby a third question is asked at step 1906 as to whether said media data is audio data 611. If the question of 1906 is answered in the affirmative, a third HTML processing condition is stated, whereby if the browser attempts to process said audio data 611 at the next step 1808 and returns an error, said browser should load the third specific media processing plugin 811 at step 1907. Control is then forwarded to step 1908.

Alternatively, the question asked at step 1906 is answered in the negative whereby a last question is asked at said step 1908 as to whether all of said media data has been preprocessed for the purpose of initialising said plugins 809, 810 and 811 according to steps 1903, 1905 and 1907 respectively. If the question at 1908 is answered in the negative, control is returned to step 1901. Alternatively, all of the media data stored in folder 803 has been preprocessed and may now be processed for binding at respective locations of the constructed HTML pages 1206 and 1210 to 1213.

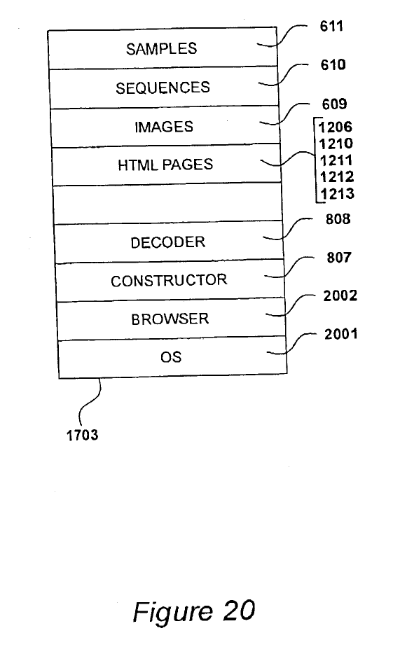

FIG. 20

The contents of main memory 1703 subsequent to completing the binding step 1808 described in FIGS. 18 and 19 are further detailed in FIG. 20.

An operating system is shown at 2001 which comprises a reduced set of instructions for CPU 1701, the purpose of which is to provide computer 1604 with basic functionality. Examples of basic functions include for instance access to files stored on hard disk drive 1705 or accessed from CD-ROM drive 1605 or disk drive 1606 and management thereof, network connectivity with network server 203 and the Internet 202, interpretation and processing of the input from keyboard 1602 and mouse 1603. In the example, the operating system is Windows Millennium Edition™ provided by the Microsoft corporation of Redmond, Calif., but it will be apparent to those skilled in the art that the instructions herein described may be easily adapted to function under different other known operating systems, such as other versions of the Windows operating system, MAC OS-X™ provided by Apple Corporation, IRIX™ provided by Silicon Graphics Inc, or LINUX, which is freely distributed.

An internet browser application is shown at 2002, which processes both hypertext mark-up language (HTML) and extended mark-up language (XML) coded data packets or other internet-specific formatted data into graphical data for display on VDU 1609. Said browser 2002 is the application called by the constructor 807 according to step 1807. Upon said constructor 807 successfully invoking said browser 2002 for processing constructed HTML pages 1206 and 1210 to 1213 for display on VDU 1609, both said constructor 807 and the decoder 808 will be deleted from memory 1703 as their functionality is no longer required.

Said HTML pages 1206 and 1210 to 1213 are shown along with media data 609 to 611, all of which were copied from removable data-carrying medium 1302 to the “temp” directory in their respective file folders 804, 803, the respective layout, contents and position thereof having been generated when processing the XML script 805 at step 1804, whereby said pages are subsequently loaded into memory 1703 at step 1808.

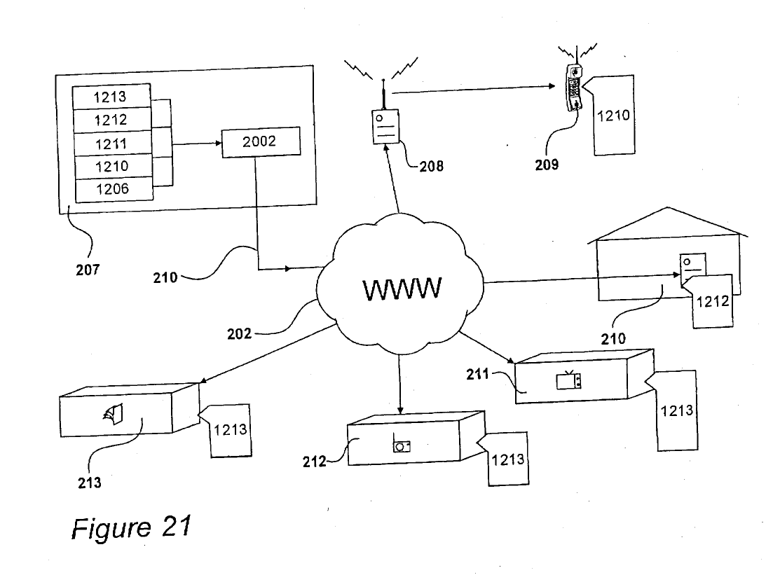

FIG. 21

HTML pages 1206 and 1210 to 1213 having respective media data 609 to 611 bound thereto may now be broadcast to raise an alert about the lost dependant according to step 1809, who in the example is child 109. Said alert may be raised by means of officer 1601 locally printing any of said HTML pages which include at least one image of child 109 from the set 1202. Preferably, however, said broadcasting is made across the networked environment first shown in FIG. 2 and is described in further detail in FIG. 21.

In the example, security officer 1601 operates security force network server 207, which is connected to the internet 202 and via which HTML pages stored in memory 1703 and/or any of the media data stored in folder 803 may be distributed to any addressable location connected thereto. Said distribution is preferably effected by browser 2002, which is an application best-configured for processing said data according to the network's distribution protocol, TCP/IP. It will be evident to those skilled in the art that many other protocols, such as NetBUI or IPX/SPX for cabled networks, or WAP (Wireless Application Protocol) for wireless networks, may perform the above distribution in various network environments, such as Wireless, Wide-Area or Local Area Networks.

In order to rapidly reunite separated dependent child 109 with responsible parent 108, the extent of the alert raised at step 1809 is maximised, wherein the HTML pages 1206 and 1210 to 1213 are selectively distributed to said addressable locations. Thus, HTML page 1210 containing only essential alphanumeric data and, most importantly, a photograph of child 109 from the set 1202, is distributed by server 207 to networked server 208 such that said page 1210 may be wirelessly distributed to mobile telephone handsets 209 carried by other security officers patrolling shopping mail 101, whereby said security officers may now rapidly identify child 109 by sight.

Preferably, page 1212 containing all of the input data 607, 608 describing child 109 and a photograph of child 109 from the set 1202, is distributed to processing system 210 operated by the police, whereby police officers may now also rapidly identify child 109 by sight, as well as broadcast said description across their own communication networks (not shown).

Similarly, page 1213 containing all of the input data 608 describing child 109, a photograph of child 109 from the set 1202 as well as other media data 611 and 1204, is distributed to processing systems 211, 212 and 213 respectively located at a television broadcasting facility, a radio broadcasting facility and a newspaper office, for the purpose of broadening the alerts if so required. Thus, said television broadcasting facility may broadcast either said photograph 1202 or said videoclip 1204 or both; said radio broadcasting facility may broadcast a description based upon alphanumeric data 608 as well as audio data 611 and said newspaper office may publish and print a description based upon alphanumeric data 608 as well as a high-resolution photograph from set 1202.

In all instances, the benefit is clear in that all of the entities involved in raising the alert upon distributing any of pages 1206 and 1210 to 1213 use the same description based upon said input data 608, wherein said description includes at least one image 1202 and thus efforts in locating child 109 can proceed immediately upon parent 108 handing over media 1302 storing said description data.

1. A method of locating a dependent person that has become separated from their caretaker in a high-density environment, comprising the steps of
receiving from said caretaker a removable data-carrying medium containing a description of said dependent person;
reading said description from said medium; and
distributing said description to a plurality of locations.

2. A method according to claim 1., wherein said high-density environment is a shopping mall.

3. A method according to claim 1., wherein said dependent person is a child.

4. A method according to claim 1., wherein said description includes image data representing said dependent person.

5. A method according to claim 1., wherein said description is encoded.

6. A method according to claim 1., wherein removable data-carrying medium is a CD-card.

7. A method according to claim 1., wherein said removable data-carrying medium additionally contains instructions that configure a computer to carry out said steps of reading and distributing said description.

8. Apparatus for raising an alert to a situation in which a dependent person has become separated from their caretaker, comprising input means configured to receive a removable data-carrying medium, processing means and output means; wherein said processing means is configured to
receive from said removable data-carrying medium, via said input means, an encoded description of said dependent person, including image data representing said person, and instructions that configure said processing means to perform the steps of:
reading and decoding said encoded description in order to generate a viewable image, and
distributing, via said output means, said viewable image to a plurality of locations.

9. Apparatus according to claim 8., wherein said encoded description is digital data and said removable data-carrying medium is configured with optical data storage means.

10. Apparatus according to claim 8., wherein said encoded description is digital data and said removable data-carrying medium is configured with magnetic data storage means.

11. Apparatus according to claim 8., wherein said processing means further receives from said removable data-carrying medium an encoded description of said caretaker.

12. Apparatus according to claim 8., wherein said processing means decodes said encoded description by means of a decoder module included in said instructions.

13. Apparatus according to claim 5, wherein said decoder module parses said encoded description and upon finding a marker for image data binds said image data to a template to generate said viewable image.

14. Apparatus according to claim 8., wherein said instructions include an interpreter module.

15. Apparatus according to claim 8., wherein said instructions include a plug-in that enables said processing means to read said image data.

16. Apparatus according to claim 8., wherein said encoded description further includes data representing a sequence of image frames defining a video sequence.

17. Apparatus according to claim 16., wherein said instructions include a plug-in that enables said processing means to read said video sequence.

18. Apparatus according to claim 8., wherein said encoded description further includes a sound sample.

19. Apparatus according to claim 18., wherein said instructions include a plug-in that enables said processing means to read said sound sample.

20. Apparatus according to claim 8., wherein said apparatus and said plurality of locations are connected by a cable network, a wireless network or a combination thereof.

21. Apparatus according to claim 20., wherein said output means distributes said viewable image to said plurality of locations by means of printing or broadcasting said viewable image or sharing the decoded description, or a combination thereof.

22. Apparatus according to claim 8., wherein said apparatus further receives at least one HTML template from said removable data-carrying medium.

23. Apparatus according to claim 22., wherein said viewable image is generated by binding at least said image data to one of said HTML templates.

24. In a facility open to members of the public in which at least one dependent person is escorted by at least one caretaker, a method of raising an alert to a situation in which a dependent person has become separated from their caretaker, comprising the steps of:
receiving a removable data-carrying medium from said caretaker having an encoded description thereon of said separated dependant, including image data representing said dependant;
reading and decoding said encoded description to generate a viewable image; and
distributing said viewable image to a plurality of locations around said facility.

25. A method according to claim 24., wherein said encoded description is digital data and said removable data-carrying medium is configured with optical data storage means.

26. A method according to claim 24., wherein said encoded description is digital data and said removable data-carrying medium is configured with magnetic data storage means.

27. A method according to claim 24., wherein said encoded description further includes data representing a sequence of image frames defining a video sequence.

28. A method according to claim 24., wherein said encoded description further includes a sound sample.

29. A method according to claim 24., wherein said processing means decodes said encoded description by means of a decoder module.

30. A method according to claim 24., wherein said plurality of locations are connected by a cable network, a wireless network or a combination thereof.

31. A method according to claim 30., wherein said output means outputs said viewable image to said plurality of locations by means of printing or broadcasting said viewable image or sharing the decoded data thereof, or a combination thereof.

32. A method according to claim 24., wherein said viewable image is generated by binding at said image data to an HTML template.

33. A removable data-carrying medium having thereon an encoded description of a dependent person separated from their caretaker, including image data representing said dependent person, and computer-readable instructions executable by a computer, wherein said instructions configure a computer to raise an alert by performing the steps of
reading and decoding said encoded description;
generating a viewable image from said decoded description; and
outputting said viewable image to a plurality of locations.

34. A removable data-carrying medium according to claim 33., wherein said encoded description is digital data and said removable data-carrying medium is configured with optical data storage means.

35. A removable data-carrying medium according to claim 34., wherein said removable data-carrying medium is a CD-card.

36. A removable data-carrying medium according to claim 34., wherein said removable data-carrying medium is a mini CD-ROM.

37. A removable data-carrying medium according to claim 33., wherein said encoded description is digital data and said removable data-carrying medium is configured with magnetic data storage means.

38. A removable data-carrying medium according to claim 37., wherein said removable data-carrying medium comprises solid state memory.

39. A removable data-carrying medium according to claim 33., further having thereon an encoded description of said caretaker.

40. A removable data-carrying medium according to claim 33., further having thereon at least one encoded description of a further dependant.

41. A removable data-carrying medium according to claim 33., wherein said instructions include an interpreter module.

42. A removable data-carrying medium according to claim 33., wherein said instructions include a plug-in that enables said computer to read said image data.

43. A removable data-carrying medium according to claim 33., wherein said encoded description further includes data representing a sequence of image frames defining a video sequence.

44. A removable data-carrying medium according to claim 43., wherein said instructions include a plug-in that enables said computer to read said video sequence.

45. A removable data-carrying medium according to claim 33., wherein said encoded description further includes a sound sample.

46. A removable data-carrying medium according to claim 45., wherein said instructions include a plug-in that enables said computer to read said sound sample.

47. A removable data-carrying medium according to claim 33., further having thereon at least one HTML template.

48. A removable data-carrying medium according to claim 47., wherein said step of generating a viewable image is performed by binding at least said image data to one of said HTML templates.

49. A computer system programmed to raise an alert, comprising memory means, processing means, input means suitable for receiving a removable data-carrying medium having thereon an encoded description of a dependent person separated from their caretaker, including image data representing said dependent person, and output means; wherein said removable data-carrying medium stores instructions which program said computer to perform the steps of
reading and decoding said encoded description by means of said processing means to said memory means in order to generate a viewable image from said description; and
distributing, via said output means, said image to a plurality of locations.

50. A computer system programmed according to claim 49., wherein said processing means decodes said encoded description by means of a decoder module.

51. A computer system programmed according to claim 49., wherein said instructions include an interpreter module.

52. A computer system programmed according to claim 49., wherein said instructions include a plug-in that enables said processing means to read said image data.

53. A computer system programmed according to claim 49., wherein said encoded description further includes data representing a sequence of image frames defining a video sequence.

54. A computer system programmed according to claim 53., wherein said instructions include a plug-in that enables said processing means to read said video sequence.

55. A computer system programmed according to claim 49., wherein said encoded description further includes a sound sample.

56. A computer system programmed according to claim 55., wherein said instructions include a plug-in that enables said processing means to read said sound sample.

57. A computer system programmed according to claim 49., wherein said computer and said plurality of locations are connected by a cable network, a wireless network or a combination thereof.

58. A computer system programmed according to claim 57., wherein said output means distributes said viewable image to said plurality of locations by means of printing or broadcasting said viewable image or sharing the decoded description, or a combination thereof.

59. A computer system programmed according to claim 49., wherein said viewable image is generated by binding at least said image data to an HTML template.

60. Apparatus for encoding data and writing said encoded data onto a removable data-carrying medium, said apparatus comprising memory means, image data input means, alphanumeric data input means, processing means and data-writing means; wherein said processing means is configured to perform the steps of
receiving data comprising a description of a dependent person from said image data input means and from said alphanumeric data input means, wherein said description comprises image data representing said dependent person and alphanumeric data;
referencing said data in a database;
encoding said description by means of processing said database with an encoder module, and
writing, via said data-writing means, said encoded description onto said removable data-carrying medium.

61. Apparatus according to claim 60., wherein said data further comprises a description of a caretaker of said dependent person and said further description is also encoded and written to said medium.

62. Apparatus according to claim 61., wherein said data further comprises descriptions of at least one further person dependent on said caretaker and said further descriptions are also encoded and written to said medium.

63. Apparatus according to claim 60. further comprising audio data input means and video data input means, wherein said description of said dependent person further includes audio and video data received from said audio and video data input means.

64. Apparatus according to claim 60., wherein said encoded description is digital data and said removable data-carrying medium is configured with optical data storage means.

65. Apparatus according to claim 60., wherein said encoded description is digital data and said removable data-carrying medium is configured with magnetic data storage means.

66. Apparatus according to claim 60., wherein said encoder module processes said database into a script.

67. Apparatus according to claim 66., wherein said script is an extended mark-up language (XML) script.

68. Apparatus according to claim 60., wherein said processing means is further configured to perform the step of writing an instruction set to said removable data-carrying medium.

69. Apparatus according to claim 60., wherein said processing means is further configured to perform the step of writing at least one HTML template to said removable data-carrying medium.

70. A method of encoding writing data onto a removable data-carrying medium, said method comprising the steps of
obtaining a description of a dependent person comprising image data representing said person and alphanumeric data;
referencing said image data and alphanumeric data in a database;
encoding said description by means of processing said database with an encoder module; and
writing said encoded description onto said removable data-carrying medium.

71. A method according to claim 70., wherein said description further includes audio and video data and said audio and video data is also referenced in said database.

72. A method according to claim 70., wherein said encoded description is digital data and said removable data-carrying medium is configured with optical data storage means.

73. A method according to claim 70., wherein said encoded description is digital data and said removable data-carrying medium is configured with magnetic data storage means.

74. A method according to claim 70., wherein said encoder module processes said database into a script.

75. A method according to claim 74., wherein said script is an extended mark-up language (XML) script.

76. A method according to claim 70., further comprising the step of writing an instruction set to said removable data-carrying medium.

77. A method according to claim 70., further comprising the step of writing at least one HTML template to said removable data-carrying medium.

78. A computer-readable medium having computer-readable instructions executable by a computer, wherein said instructions configure said computer to
obtain a description of a dependent person comprising image data representing said dependent person and alphanumeric data;
reference said image data and said alphanumeric data in a database;
encode said description by means of processing said database with an encoder module; and
write said encoded description onto a removable data-carrying medium.

79. A computer-readable medium according to claim 78., wherein said description further includes audio and video data and said instructions further configure said computer to reference said audio and video data in said database.

80. A computer-readable medium according to claim 78., wherein said encoder module processes said database into a script.

81. A computer-readable medium according to claim 80., wherein said script is an extended mark-up language (XML) script.

82. A computer-readable medium according to claim 78., wherein said instructions further configure said computer to write an instruction set to said removable data-carrying medium.

83. A computer-readable medium according to claim 78., wherein said instructions further configure said computer to write at least one HTML template to said removable data-carrying medium.

84. A computer system programmed to encode data and write said encoded data onto a removable data-carrying medium, said computer system comprising memory means, image data input means, alphanumeric data input means, processing means and data-writing means; wherein said memory means stores instructions which program said processing means to perform the steps of
receiving data comprising a description of a dependent person from said image data input means and from said alphanumeric data input means, wherein said description comprises image data representing said dependent person and alphanumeric data;
referencing said image data and alphanumeric data in a database;
encoding said description by means of processing said database with an encoder module; and
writing, via said data-writing means, said encoded description onto said removable data-carrying medium.

85. A computer system programmed according to claim 84., wherein said data further comprises a description of a caretaker of said dependent person and said further description is also encoded and written to said medium.

86. A computer system programmed according to claim 85., wherein said data further comprises descriptions of at least one further person dependent on said caretaker and said further descriptions are also encoded and written to said medium.

87. A computer system programmed according to claim 84. further comprising audio data input means and video data input means, wherein said description of said dependent person further includes audio and video data received from said audio and video data input means.

88. A computer-readable medium according to claim 84., wherein said encoder module processes said database into a script.
